(19) United States
(12) Patent Application Publication
(10) Pub. No.: US 2025/0014546 A1
(43) Pub. Date: Jan. 9, 2025

(54) EMERGENT MUSICAL PHENOTYPES BLENDED WITH SELECTIONS

(71) Applicant: INTERNATIONAL BUSINESS MACHINES CORPORATION, ARMONK, NY (US)

(72) Inventors: Aaron K. Baughman, Cary, NC (US); Stephen C Hammer, Marietta, GA (US); Sara Perelman, New York, NY (US); Jeremy R. Fox, Georgetown, TX (US)

(21) Appl. No.: 18/346,307

(22) Filed: Jul. 3, 2023

(51) Int. Cl. G10H 1/00

(52) U.S. Cl. CPC G10H 1/0025

(57) ABSTRACT

An embodiment for blending musical phenotypes with user selections is provided. The embodiment may include receiving a corpus of songs selected by a user and one or more preferences of the user relating to musical interests. The embodiment may also include converting each song in the corpus into a spectrogram. The embodiment may further include encoding each spectrogram into a chromosomal representation of integers. The embodiment may also include creating pools of chromosomal positions. The embodiment may further include processing the pools of chromosomal positions into a gene representation. The embodiment may also include translating the gene representation into a phenotype expression.

### BACKGROUND

The present invention relates generally to the field of computing, and more particularly to a system for blending musical phenotypes with user selections.

Music is a media that brings artists and fans together like no other. The unique qualities of songs attract fans to the music artists who write them. For example, a fan who likes jazz music may be drawn to a music artist who focuses exclusively or almost exclusively on jazz music. Music artists, fans, and other organizations want to be closer to their favorite music and understand how their favorite songs relate to award winning songs. Specifically, the music artists, fans, and other organizations want to understand how archetypes of the songs have changed over time and thus, the key traits that make up award winning music over the years.

### SUMMARY

According to one embodiment, a method, computer system, and computer program product for blending musical phenotypes with user selections is provided. The embodiment may include receiving a corpus of songs selected by a user and one or more preferences of the user relating to musical interests. The embodiment may also include converting, by discrete fast Fourier transforms, each song in the corpus into a spectrogram. The embodiment may further include encoding each spectrogram into a chromosomal representation of integers. The embodiment may also include creating, by a residual neural network, pools of chromosomal positions based on the chromosomal representation of integers. The embodiment may further include processing the pools of chromosomal positions into a gene representation. The embodiment may also include translating the gene representation into a phenotype expression based on the one or more preferences of the user and an environment of the user.

### BRIEF DESCRIPTION OF THE SEVERAL VIEWS OF THE DRAWINGS

These and other objects, features and advantages of the present invention will become apparent from the following detailed description of illustrative embodiments thereof, which is to be read in connection with the accompanying drawings. The various features of the drawings are not to scale as the illustrations are for clarity in facilitating one skilled in the art in understanding the invention in conjunction with the detailed description. In the drawings:

FIG. 1 illustrates an exemplary computing environment according to at least one embodiment.

FIGS. 2A and 2B illustrate an operational flowchart for blending musical phenotypes with user selections in a musical phenotype blending process according to at least one embodiment.

FIG. 3 is an exemplary diagram depicting music insights according to at least one embodiment.

### DETAILED DESCRIPTION

Detailed embodiments of the claimed structures and methods are disclosed herein; however, it can be understood that the disclosed embodiments are merely illustrative of the claimed structures and methods that may be embodied in various forms. This invention may, however, be embodied in many different forms and should not be construed as limited to the exemplary embodiments set forth herein. In the description, details of well-known features and techniques may be omitted to avoid unnecessarily obscuring the presented embodiments.

It is to be understood that the singular forms “a,” “an,” and “the” include plural referents unless the context clearly dictates otherwise. Thus, for example, reference to “a component surface” includes reference to one or more of such surfaces unless the context clearly dictates otherwise.

Embodiments of the present invention relate to the field of computing, and more particularly to a system for blending musical phenotypes with user selections. The following described exemplary embodiments provide a system, method, and program product to, among other things, translate a gene representation into a phenotype expression based on one or more preferences of a user and an environment of the user and, accordingly, change, by optimal transport, one or more songs in a corpus of songs selected by the user in accordance with a resulting spectrogram. Therefore, the present embodiment has the capacity to improve artificial intelligence (AI) processing technology by reducing the resources required to process media.

As previously described, music is a media that brings artists and fans together like no other. The unique qualities of songs attract fans to the music artists who write them. For example, a fan who likes jazz music may be drawn to a music artist who focuses exclusively or almost exclusively on jazz music. Music artists, fans, and other organizations want to be closer to their favorite music and understand how their favorite songs relate to award winning songs. Specifically, the music artists, fans, and other organizations want to understand how archetypes of the songs have changed over time and thus, the key traits that make up award winning music over the years. Music organizations often struggle to present nominees and winners within a transparent methodology of why certain music was nominated and awarded in different categories. This problem is typically addressed by manually assigning categories to thousands of nomination submissions. However, manually assigning categories fails to accurately determine the genre of a variety of songs.

It may therefore be imperative to have a system in place to facilitate music exploration, understanding, and transparency during the nomination process. Thus, embodiments of the present invention may provide advantages including, but not limited to, reducing the resources required to process media, accurately determining the genre of a large number of songs, and changing user-selected songs based on discovered phenotypes. The present invention does not require that all advantages need to be incorporated into every embodiment of the invention.

According to at least one embodiment, when modifying music, a corpus of songs selected by a user and one or more preferences of the user relating to musical interests may be received in order to convert, by discrete fast Fourier transforms, each song in the corpus into a spectrogram. Upon converting each song, each spectrogram may be encoded into a chromosomal representation of integers so that pools of chromosomal positions may be created, by a residual neural network, based on the chromosomal representation of integers. Then, the pools of chromosomal positions may be processed into a gene representation such that the gene representation may be translated into a phenotype expression based on the one or more preferences of the user and an environment of the user.

According to at least one other embodiment, upon translating the gene representation, a first phenotype representation vector may be created for a first musical selection and a second phenotype representation vector may be created for a second musical selection based on the phenotype expression, where the first phenotype representation vector and the second phenotype representation vector may be paired together based on similarity in order to execute a one-point crossover between a pivot point that is most different between the first phenotype representation vector and the second phenotype representation vector. Then, a second phenotype expression from a corpus of non-selected songs may be obtained based on the one or more preferences of the user and the environment of the user so that a directed acyclic graph (DAG) may be generated based on a first resulting phenotype representation vector from selected songs and a second resulting phenotype representation vector from non-selected songs.

According to at least one further embodiment, upon generating the DAG, nodes of the DAG may be translated into a resulting spectrogram in order to change, by optimal transport, one or more songs in the corpus of songs selected by the user in accordance with the resulting spectrogram.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

The following described exemplary embodiments provide a system, method, and program product to translate a gene representation into a phenotype expression based on one or more preferences of a user and an environment of the user and, accordingly, change, by optimal transport, one or more songs in a corpus of songs selected by the user in accordance with a resulting spectrogram.

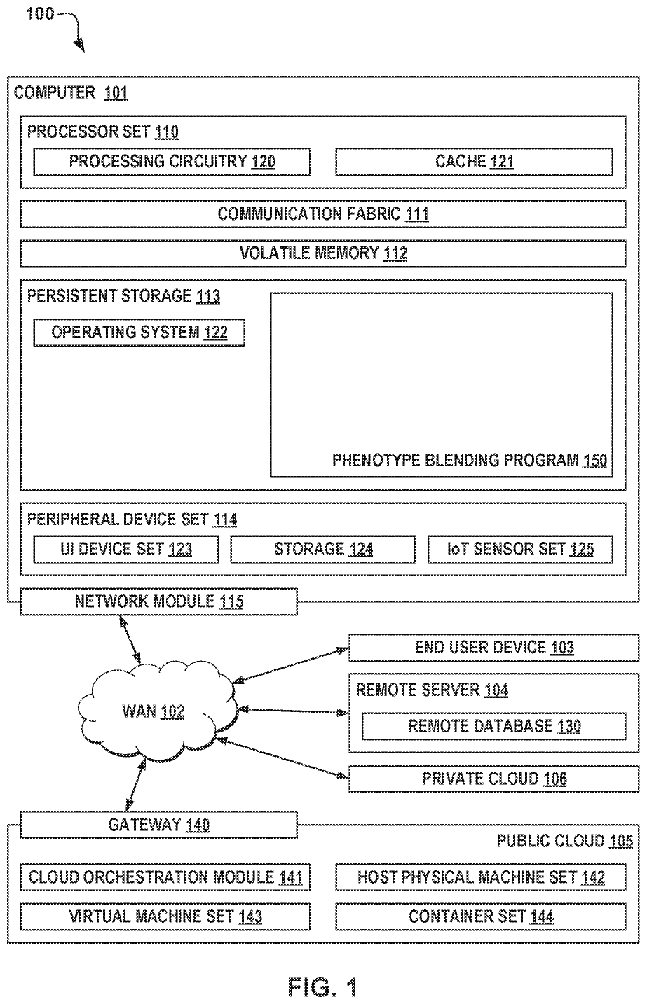

Referring to FIG. 1, an exemplary computing environment 100 is depicted, according to at least one embodiment. Computing environment 100 contains an example of an environment for the execution of at least some of the computer code involved in performing the inventive methods, such as a phenotype blending program 150. In addition to block 150, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

Computer 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

Processor set 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

Communication fabric 111 is the signal conduction paths that allow the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile memory 112 is any type of volatile memory now known or to be developed in the future. Examples include dynamic type random access memory (RAM) or static type RAM. Typically, the volatile memory 112 is characterized by random access, but this is not required unless affirmatively indicated. In computer 101, the volatile memory 112 is located in a single package and is internal to computer 101, but, alternatively or additionally, the volatile memory 112 may be distributed over multiple packages and/or located externally with respect to computer 101.

Persistent storage 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage 113 allows writing of data, deletion of data and re-writing of data. Some familiar forms of persistent storage 113 include magnetic disks and solid state storage devices. Operating system 122 may take several forms, such as various known proprietary operating systems or open source Portable Operating System Interface type operating systems that employ a kernel. The code included in block 150 typically includes at least some of the computer code involved in performing the inventive methods.

Peripheral device set 114 includes the set of peripheral devices of computer 101. Data communication connections between the peripheral devices 114 and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database), this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

Network module 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN 102 and/or LANs typically include computer hardware such as copper transmission cables, optical transmission fibers, wireless transmission, routers, firewalls, switches, gateway computers and edge servers.

End user device (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

Remote server 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

Public cloud 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 106 is similar to public cloud 105, except that the computing resources are only available for use by a single enterprise. While private cloud 106 is depicted as being in communication with WAN 102, in other embodiments the private cloud 106 may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

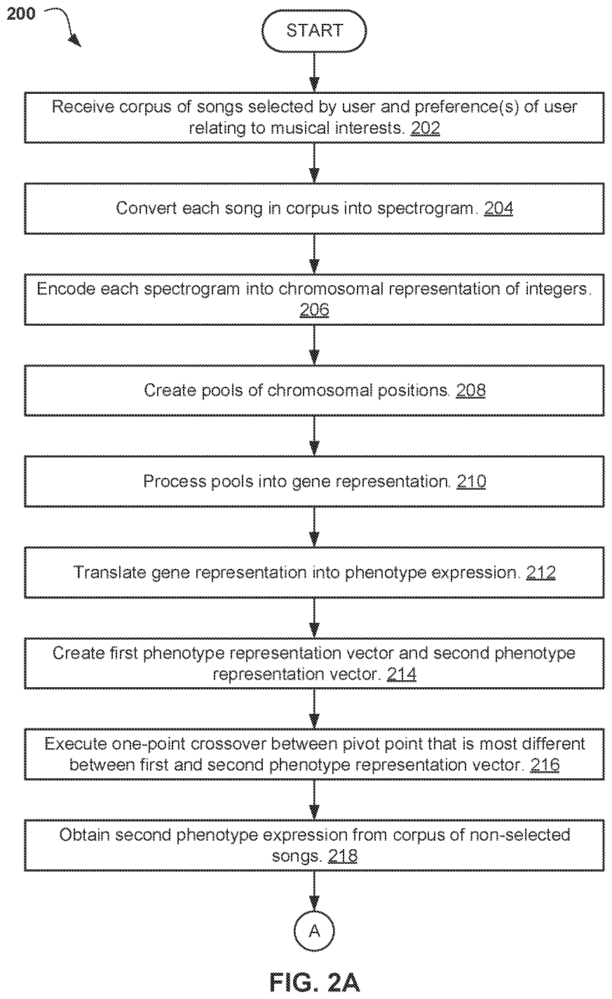

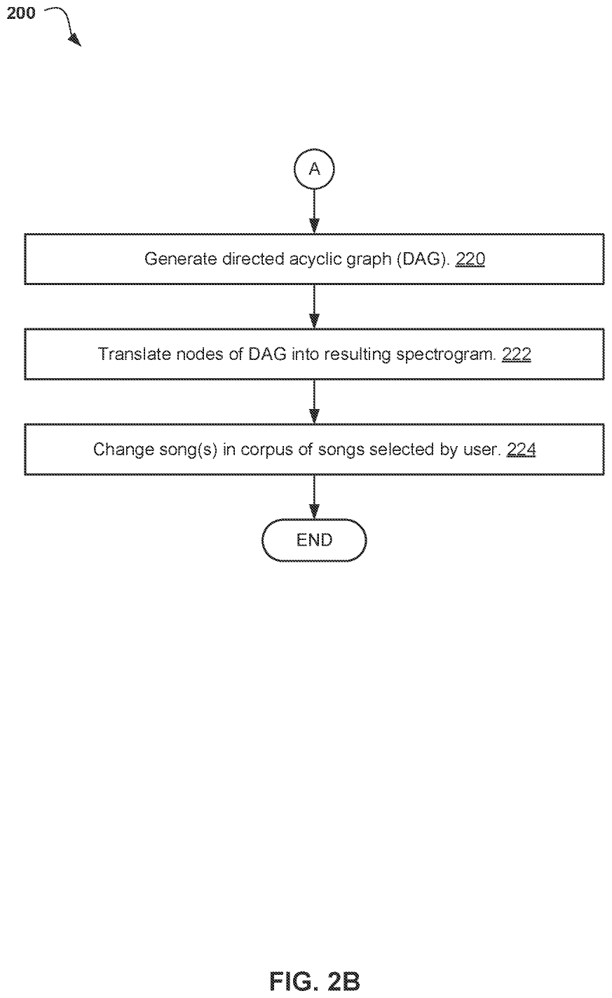

According to the present embodiment, the phenotype blending program 150 may be a program capable of receiving a corpus of songs selected by a user and one or more preferences of the user relating to musical interests, translating a gene representation into a phenotype expression based on the one or more preferences of the user and an environment of the user and, changing, by optimal transport, one or more songs in the corpus of songs selected by the user in accordance with a resulting spectrogram, reducing the resources required to process media, accurately determining the genre of a large number of songs, and changing user-selected songs based on discovered phenotypes. Furthermore, notwithstanding depiction in computer 101, the phenotype blending program 150 may be stored in and/or executed by, individually or in any combination, end user device 103, remote server 104, public cloud 105, and private cloud 106. The phenotype blending method is explained in further detail below with respect to FIGS. 2A and 2B. It may be appreciated that the examples described below are not intended to be limiting, and that in embodiments of the present invention the parameters used in the examples may be different.

Referring now to FIGS. 2A and 2B, an operational flowchart for blending musical phenotypes with user selections in a musical phenotype blending process 200 is depicted according to at least one embodiment. At 202, the phenotype blending program 150 receives the corpus of songs selected by the user and the one or more preferences of the user relating to musical interests. The corpus of songs selected by the user may include songs in a playlist and/or individual songs by an artist. For example, the playlist may include songs released between the years 1960 and 1970.

The one or more preferences of the user may include, but are not limited to, favorite songs, genres, instruments, and/or artists. For example, the user may like songs and artists from the 1960s in the popular music (i.e., pop) genre. Continuing the example, the favorite songs of the user may be songs including drums and/or a guitar.

Then, at 204, the phenotype blending program 150 converts each song in the corpus of songs into a spectrogram. Each song in the corpus is converted by discrete fast Fourier transforms. The spectrogram may be a picture representation of sound. In the spectrogram, time may run from left (oldest) to right (youngest) along the horizontal axis. The vertical axis may represent frequency, with the lowest frequencies at the bottom and the highest frequencies at the top. The amplitude of a particular frequency at a particular time may be represented by color. For example, dark blues may correspond to low amplitudes and brighter colors up through red may correspond to progressively stronger amplitudes.

Next, at 206, the phenotype blending program 150 encodes each spectrogram into a chromosomal representation of integers. As used herein, a “chromosomal representation” means a data representation of each spectrogram. Each spectrogram may be encoded into a positive integer value, such as zeroes and ones on a single linear strand.

Then, at 208, the phenotype blending program 150 creates the pools of chromosomal positions. The pools of chromosomal positions are created by a residual neural network based on the chromosomal representation of integers. According to at least one embodiment, the residual neural network may be residual before a pooling layer. The pooling layer may group the chromosomal positions (i.e., the ones and zeroes that are on multiple linear strands) and average them together into a single layer. For example, four positions on a linear strand may be interpreted into a single position. The pooling may be performed for the chromosomal representation of each spectrogram. Continuing the example described above where the four positions on a linear strand may be interpreted into a single position, the resulting pools may include four distinct values, described in further detail below with respect to step 210.

Next, at 210, the phenotype blending program 150 processes the pools of chromosomal positions into a gene representation. Pooling layers preceded by several residual neural networks may nest together a plurality of genes such that each pooling layer reduces the dimensionality of the song representation. According to at least one embodiment, the gene representation may be an average of the values of the pools. For example, where the resulting pools may include four distinct values, the gene representation may be an average of the four values.

Then, at 212, the phenotype blending program 150 translates the gene representation into a phenotype expression. The translation is based on the one or more preferences of the user and the environment of the user. The single pool obtained above with respect to step 210 that makes up the gene representation may be translated into the phenotype. As used herein, a “phenotype” means an expression of the gene within the context of the environment of the user. As used herein, an “environment” of the user means a musical field, such as a time period in which the songs were created.

According to at least one embodiment, and as described above with respect to step 202, the one or more preferences of the user may include, but are not limited to, favorite songs, genres, instruments, and/or artists. Each of these words may be converted into a word embedding in the form of a user environment vector. The user environment vector may represent a time period in which the user is interested. For example, the user may be interested in music from the 1960s and 1970s. The user may input the one or more preferences via a graphical user interface (GUI). Concurrently, the user may submit queries that are relevant to the selected time period and culture and data may be retrieved from the internet based on the queries. The natural language text may be enriched into concepts and entities that are combined together into a word embedding for a genre classification. For example, the user may input, “My favorite genre is classic rock from the 1960s and 1970s and I like songs that have the guitar.” A genre classifier may be trended over time where the natural language is stratified based on time. Additionally, the concepts and the entities derived from the natural language may be trended over time as well. In this manner, a user context vector becomes static and combined with each trended environment vector given a time stamp. The user context vector may represent the one or more preferences of the user.

According to at least one other embodiment, the user context vector and each trended environment vector may be fed into a feed forward neural network to recognize genres. However, the user context vector may bias the interpretation of the feed forward neural network. For example, an American rap artist may appear in a foreign language song. Continuing the example, assuming the user has an affinity for rap music, the classification of the foreign language song may be biased to be rap.

Next, at 214, the phenotype blending program 150 creates the first phenotype representation vector for the first musical selection and the second phenotype representation vector for the second musical selection. The creation is based on the phenotype expression. As used herein, a “phenotype representation vector” means the output of the genre classifier that recognizes genres given genes, user preferences, and the user environment. The output may include a series of numbers in a row. According to at least one embodiment, the musical selection may include an individual song. According to at least one other embodiment, the musical selection may include a group of songs. In either embodiment, several phenotype representation vectors may be created. Each of the phenotype representation vectors, such as the first phenotype representation vector and the second phenotype representation vector, may be paired together based on similarity.

Then, at 216, the phenotype blending program 150 executes the one-point crossover between the pivot point that is most different between the first phenotype representation vector and the second phenotype representation vector. The first phenotype representation vector and the second phenotype representation vector may swap phenotype values at the pivot point.

According to at least one embodiment, a random jitter mutation may be applied to each phenotype representation vector having the swapped phenotype values to anneal the searching algorithm out of local optimums.

For example, the songs in the corpus of songs selected by the user may include several drum components, which may imply the favorite instrument of the user is drums. However, this may not necessarily be the case. Thus, the random jitter mutation may randomly shift the confidence level in the favorite instrument of the user being drums.

Next, at 218, the phenotype blending program 150 obtains the second phenotype expression from the corpus of non-selected songs. The second phenotype expression may be obtained based on the one or more preferences of the user and the environment of the user. The corpus of non-selected songs may include songs in a different playlist and/or different individual songs by an artist. For example, the non-selected playlist may include songs released between the years 1960 and 1970.

According to at least one embodiment, obtaining the second phenotype expression may include creating a third phenotype representation vector for a first non-selected song and a fourth phenotype representation vector for a second non-selected song. The third phenotype representation vector and the fourth phenotype representation vector may be created based on the second phenotype expression. Similar to step 214 described above, the third phenotype representation vector and the fourth phenotype representation vector may also be paired together based on similarity. Similar to step 216 described above, a second one-point crossover may then be executed between a second pivot point that is most different between the third phenotype representation vector and the fourth phenotype representation vector. The third phenotype representation vector and the fourth phenotype representation vector may swap phenotype values at the second pivot point.

According to at least one further embodiment, a second random jitter mutation may be applied to each phenotype representation vector for non-selected songs having the swapped phenotype values to anneal the searching algorithm out of local optimums.

Then, at 220, the phenotype blending program 150 generates the DAG. The DAG may be generated based on the first resulting phenotype representation vector from selected songs and the second resulting phenotype representation vector from non-selected songs. As used herein, a “resulting phenotype representation vector” means a phenotype representation vector that has been crossed-over and/or mutated. The first resulting phenotype representation vector may be derived from the corpus of songs selected by the user, whereas the second resulting phenotype representation vector may be derived from the corpus of non-selected songs. Thus, the first resulting phenotype representation vector may be labeled as user-selected and the second resulting phenotype representation vector may be labeled as not user-selected.

According to at least one embodiment, the labeled first resulting phenotype representation vector and the labeled second resulting phenotype representation vector may be utilized as training data by a modified notears algorithm to generate the DAG. Each of the nodes of the DAG may map to a specific phenotype. The DAG may enable automatic and/or user what-if scenarios to infer a resulting graph of nodes with probabilities. For example, the user may input a query into the GUI such as, “Why do I like certain kinds of songs?” Continuing the example, the DAG may be utilized by the phenotype blending program 150 to answer “You like these songs in the playlist because of the guitar and bass elements.”

According to at least one other embodiment, the one or nodes of the DAG may be adapted in response to negative feedback from the user. Continuing the example described above where the DAG is utilized to provide the answer, the user may input a response into the GUI such as, “I like this group of songs because of the melody and lyrics.” In this embodiment, the nodes of the DAG may be adapted based on these user preferences.

Next, at 222, the phenotype blending program 150 translates the nodes of the DAG into the resulting spectrogram. As used herein, a “resulting spectrogram” means a spectrogram that is generated from inference results and/or averaged inference results of the DAG. The amplitude versus frequency representation may be learned and inferred by a feed forward neural network, where each output node may represent a frequency and the numerical magnitude may represent a musical amplitude. The resulting spectrogram may be an archetype. The archetype may be a personalized generation of an emerging genre (e.g., a combination of classic rock and country music). Each song in the corpus of songs selected by the user and/or new selections by the user may be influenced by the archetype, described in further detail below with respect to step 224.

Then, at 224, the phenotype blending program 150 changes the one or more songs in the corpus of songs selected by the user and/or the new selections by the user in accordance with the resulting spectrogram. Each of the songs may be changed by optimal transport. Optimal transport may change any user-selected song into a form that matches the archetype. For example, the resulting spectrogram may make a 2000s song resemble songs from the 1960s. According to at least one embodiment, the lyrics may remain the same while other elements of the song (e.g., melody, harmony, timbre, and/or instruments) may be changed. According to at least one other embodiment, the lyrics and other elements of the song may be changed. In either embodiment, the resulting spectrogram may be reverse discrete Fourier transformed into a form with amplitude over time. In this manner, each of the songs may be converted into one or more audio files (e.g., MP3 and/or WAV).

According to at least one embodiment, changing, by optimal transport, the one or more songs selected by the user and/or the new selections by the user in accordance with the resulting spectrogram may include generating one or more new genre categories and matching the changed one or more songs to at least one of the one or more new genre categories. For example, where a changed songs combines elements of R&B with contemporary pop, the new genre category may be “New R&B” and the specific changed song may be matched with that new genre category.

According to at least one other embodiment, music styles of artists by their aggregated record label may be mixed with the trending array for various musicians that are trending on social media. A database of artist information belonging to a record label and a social media database of trending musicians may be accessed by the phenotype blending program 150. The database of artist information and/or the social media database may be accessed by a user. One or more artists from the database of artist information that are trending on social media may be selected. The music styles of the selected one or more artists may be mixed together manually and/or automatically. The mixed music styles may then be output in the form of a playlist and/or song.

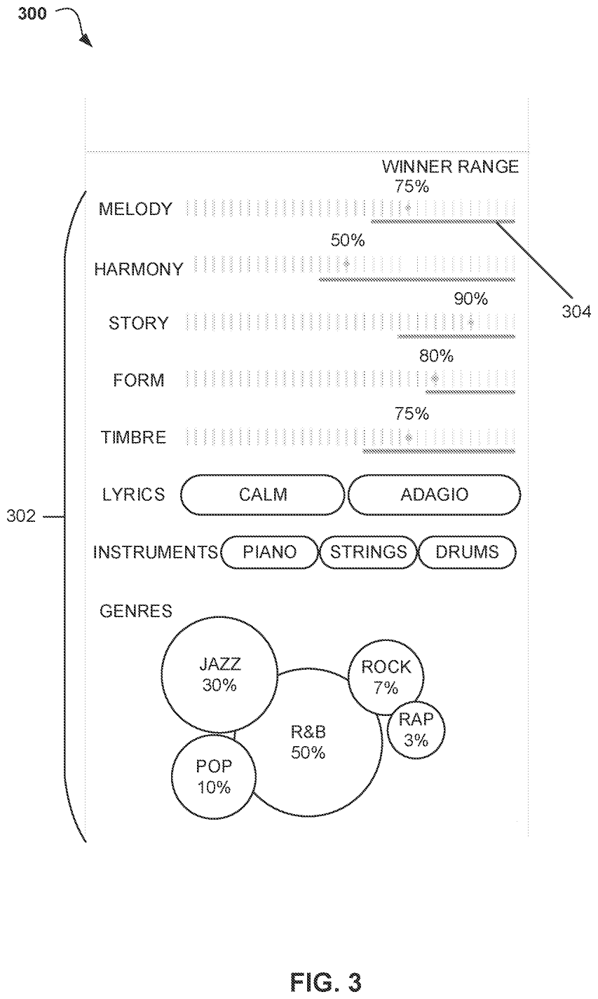

Referring now to FIG. 3, an exemplary diagram 300 depicting music insights is shown according to at least one embodiment. In the diagram 300, music insights may be made regarding song elements 302. For example, the song elements 302 may include melody, harmony, story, form, timbre, lyrics, instruments, and genres. One or more of the song elements 302 may be assigned a percentage score. Underlines 304 below the percentage scores may illustrate whether the percentage scores are within ranges of award winning songs. Additionally, the lyrics may be classified and instruments may be listed for a particular song. For example, the lyrics may be classified as “Calm” and “Adagio” and the listed instruments may be “Plano,” “Strings,” and “Drums.” Furthermore, a main genre may be displayed along with sub-genres with each of the main genre and sub-genres assigned a percentage. For example, the main genre may be 50% R&B, and the sub-genres may be 30% Jazz, 10% Pop, 7% Rock, and 3% Rap. The percentages assigned to the main genre and sub-genres for the particular song may be used to recommend additional songs that are similar to that particular song.

It may be appreciated that FIGS. 2A, 2B, and 3 provide only an illustration of one implementation and do not imply any limitations with regard to how different embodiments may be implemented. Many modifications to the depicted environments may be made based on design and implementation requirements.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-based method of blending musical phenotypes with user selections, the method comprising:
receiving a corpus of songs selected by a user and one or more preferences of the user relating to musical interests;
converting, by discrete fast Fourier transforms, each song in the corpus into a spectrogram;
encoding each spectrogram into a chromosomal representation of integers;
creating, by a residual neural network, pools of chromosomal positions based on the chromosomal representation of integers;
processing the pools of chromosomal positions into a gene representation; and
translating the gene representation into a phenotype expression based on the one or more preferences of the user and an environment of the user.

2. The computer-based method of claim 1, further comprising:
creating a first phenotype representation vector for a first musical selection and a second phenotype representation vector for a second musical selection based on the phenotype expression, wherein the first phenotype representation vector and the second phenotype representation vector are paired together based on similarity;
executing a one-point crossover between a pivot point that is most different between the first phenotype representation vector and the second phenotype representation vector;
obtaining a second phenotype expression from a corpus of non-selected songs based on the one or more preferences of the user and the environment of the user, wherein obtaining the second phenotype expression further comprises:
creating a third phenotype representation vector for a first non-selected song and a fourth phenotype representation vector for a second non-selected song; and
generating a directed acyclic graph (DAG) based on a first resulting phenotype representation vector from selected songs and a second resulting phenotype representation vector from non-selected songs.

3. The computer-based method of claim 2, wherein the first resulting phenotype representation vector is labeled as user-selected and the second resulting phenotype representation vector is labeled as not user-selected, and wherein the labeled first resulting phenotype representation vector and the labeled second resulting phenotype representation vector are utilized by a modified notears algorithm to generate the DAG.

4. The computer-based method of claim 2, further comprising:
translating nodes of the DAG into a resulting spectrogram; and
changing, by optimal transport, one or more songs in the corpus of songs selected by the user in accordance with the resulting spectrogram.

5. The computer-based method of claim 4, wherein one or more nodes of the DAG are adapted in response to negative feedback from the user.

6. The computer-based method of claim 4, wherein changing, by optimal transport, the one or more songs in the corpus of songs selected by the user in accordance with the resulting spectrogram further comprises:
generating one or more new genre categories and matching the changed one or more songs to at least one of the one or more new genre categories.

7. The computer-based method of claim 4, wherein the resulting spectrogram is reverse discrete Fourier transformed into a form with amplitude over time.

8. A computer system, the computer system comprising:
one or more processors, one or more computer-readable memories, one or more computer-readable tangible storage medium, and program instructions stored on at least one of the one or more computer-readable tangible storage medium for execution by at least one of the one or more processors via at least one of the one or more computer-readable memories, wherein the computer system is capable of performing a method comprising:
receiving a corpus of songs selected by a user and one or more preferences of the user relating to musical interests;
converting, by discrete fast Fourier transforms, each song in the corpus into a spectrogram;
encoding each spectrogram into a chromosomal representation of integers;
creating, by a residual neural network, pools of chromosomal positions based on the chromosomal representation of integers;
processing the pools of chromosomal positions into a gene representation; and
translating the gene representation into a phenotype expression based on the one or more preferences of the user and an environment of the user.

9. The computer system of claim 8, the method further comprising:
creating a first phenotype representation vector for a first musical selection and a second phenotype representation vector for a second musical selection based on the phenotype expression, wherein the first phenotype representation vector and the second phenotype representation vector are paired together based on similarity;
executing a one-point crossover between a pivot point that is most different between the first phenotype representation vector and the second phenotype representation vector;
obtaining a second phenotype expression from a corpus of non-selected songs based on the one or more preferences of the user and the environment of the user, wherein obtaining the second phenotype expression further comprises:
creating a third phenotype representation vector for a first non-selected song and a fourth phenotype representation vector for a second non-selected song; and
generating a directed acyclic graph (DAG) based on a first resulting phenotype representation vector from selected songs and a second resulting phenotype representation vector from non-selected songs.

10. The computer system of claim 9, wherein the first resulting phenotype representation vector is labeled as user-selected and the second resulting phenotype representation vector is labeled as not user-selected, and wherein the labeled first resulting phenotype representation vector and the labeled second resulting phenotype representation vector are utilized by a modified notears algorithm to generate the DAG.

11. The computer system of claim 9, the method further comprising:
translating nodes of the DAG into a resulting spectrogram; and
changing, by optimal transport, one or more songs in the corpus of songs selected by the user in accordance with the resulting spectrogram.

12. The computer system of claim 11, wherein one or more nodes of the DAG are adapted in response to negative feedback from the user.

13. The computer system of claim 11, wherein changing, by optimal transport, the one or more songs in the corpus of songs selected by the user in accordance with the resulting spectrogram further comprises:
generating one or more new genre categories and matching the changed one or more songs to at least one of the one or more new genre categories.

14. The computer system of claim 11, wherein the resulting spectrogram is reverse discrete Fourier transformed into a form with amplitude over time.

15. A computer program product, the computer program product comprising:
one or more computer-readable tangible storage medium and program instructions stored on at least one of the one or more computer-readable tangible storage medium, the program instructions executable by a processor capable of performing a method, the method comprising:
receiving a corpus of songs selected by a user and one or more preferences of the user relating to musical interests;
converting, by discrete fast Fourier transforms, each song in the corpus into a spectrogram;
encoding each spectrogram into a chromosomal representation of integers;
creating, by a residual neural network, pools of chromosomal positions based on the chromosomal representation of integers;
processing the pools of chromosomal positions into a gene representation; and
translating the gene representation into a phenotype expression based on the one or more preferences of the user and an environment of the user.

16. The computer program product of claim 15, the method further comprising:
creating a first phenotype representation vector for a first musical selection and a second phenotype representation vector for a second musical selection based on the phenotype expression, wherein the first phenotype representation vector and the second phenotype representation vector are paired together based on similarity;
executing a one-point crossover between a pivot point that is most different between the first phenotype representation vector and the second phenotype representation vector;
obtaining a second phenotype expression from a corpus of non-selected songs based on the one or more preferences of the user and the environment of the user, wherein obtaining the second phenotype expression further comprises:
creating a third phenotype representation vector for a first non-selected song and a fourth phenotype representation vector for a second non-selected song; and
generating a directed acyclic graph (DAG) based on a first resulting phenotype representation vector from selected songs and a second resulting phenotype representation vector from non-selected songs.

17. The computer program product of claim 16, wherein the first resulting phenotype representation vector is labeled as user-selected and the second resulting phenotype representation vector is labeled as not user-selected, and wherein the labeled first resulting phenotype representation vector and the labeled second resulting phenotype representation vector are utilized by a modified notears algorithm to generate the DAG.

18. The computer program product of claim 16, the method further comprising:
translating nodes of the DAG into a resulting spectrogram; and
changing, by optimal transport, one or more songs in the corpus of songs selected by the user in accordance with the resulting spectrogram.

19. The computer program product of claim 18, wherein one or more nodes of the DAG are adapted in response to negative feedback from the user.

20. The computer program product of claim 18, wherein changing, by optimal transport, the one or more songs in the corpus of songs selected by the user in accordance with the resulting spectrogram further comprises:
generating one or more new genre categories and matching the changed one or more songs to at least one of the one or more new genre categories.
